(19) United States
(12) Patent Application Publication
(10) Pub. No.: US 2008/0033979 A1
(43) Pub. Date: Feb. 7, 2008

(54) Integrated Playlist Generator

(75) Inventors: Fabio Vignoli, Veldhoven (NL); Steffen Clarence Pauws, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,280

(22) PCT Filed: Jan. 17, 2005
(86) PCT No.: PCT/IB05/50185

§ 371 Date: Jul. 19, 2006

Related U.S. Application Data
(60) Provisional application No. 60/537,798, filed on Jan. 20, 2004.

(51) Int. Cl. G06F 7/00

(52) U.S. Cl. 707/102

(57) ABSTRACT

A system and method for playlist generation is configured to augment a playlist derived from selections from a user's collection with selections from beyond the user's collection. Both the user's collection and external sources are searched for entertainment items that conform to the user's preferences, and the resultant playlist includes a mix of material from both the user's collection and the external sources. The user is provided the option of specifying the proportion of material that is to be included in the playlist from the external sources. If the material from the external sources requires a purchase fee, the user is provided the option of purchasing the material, preferably, after being given the opportunity to view, listen to, or otherwise assess the material.

This invention relates to the field of entertainment systems, and in particular to a playlist generator that provides a playlist from selections contained within a user's collection of material, as well as from selection beyond the user's collection.

Playlists define a subset of identifiers of entertainment selections, such as songs, videos, multimedia segments, and so on, for subsequent rendering via a corresponding rendering device or system.

A playlist generator facilitates the creation of a playlist. Conventionally, a playlist generator receives a set of user preferences, and applies this set of preferences to a collection of material to identify selections in the collection that satisfy the set of preferences. To create a different playlist, a user modifies the preferences and submits this modified set of preferences to the playlist generator.

For ease of reference, the phrase “the playlist includes an item”, or similar phrases, is hereinafter understood to mean that the playlist includes an identifier of the item, from which a rendering device can access the recorded item for the rendering of its content. Also for ease of reference, the invention is presented in the context of a playlist generator that creates a playlist of songs. One of ordinary skill in the art will recognize that the principles presented herein are independent of the type of material being playlisted.

Generally, a playlist generator assesses a measure of correspondence between each available item in a collection of material and the set of user preferences, and identifies the items in the collection whose correspondence measure exceeds a given threshold. A variety of techniques, including weighted averaging, rule-based systems, neural networks, and the like, can be used to provide the measure of correspondence between the characteristics of each item and the given user preferences, and to identify those having the best measure of correspondence.

Typically, a user uses playlist generators in a variety of contexts. A user may use a playlist generator to create subsets of the user's collection of entertainment material. For example, the user may create playlists for dinner-music, romantic-music, eclectic-music, and so on, via a selection from among the user's collection of music. As the situation warrants, the user subsequently provides the appropriate playlist to his/her home entertainment system for rendering the identified material in the playlist from the user's collection. A user may also use a playlist generator to create a customized list of songs from a broadcast source, such as an Internet radio station. A user may also use a playlist generator to create a customized album of songs for purchase from a commercial source, such as an Internet-based vendor.

Generally, each of these contexts for creating a playlist are independent of each other. The playlist generated from the user-collection is independent of the available material from Internet radio stations and commercial vendor sites, and the playlists generated from the Internet radio stations and commercial vendor sites may or may not include material from the user-collection. For example, the playlist of songs from an Internet radio station will often include songs that are also included in the user's collection of music, particularly if the user's taste for music is consistent, and the user's collection is not insubstantial. In many instances, the reason a user is tuning to the Internet radio station is to hear music that the user does not already possess. Although some Internet radio station playlist generators allow a user to identify a proportion of ‘new music’ that is to be included in the playlist, the definition of ‘new music’ is typically “recently released music that has not yet been rated by a recognized source”, such as “Radio and Record” (R&R) magazine. See, for example, US patent application 2002/0138630, “MUSIC SELECTION ALGORITHM”, filed 19 Dec. 2001 for Solomon et al., and incorporated by reference herein. Conversely, playlist generators that are configured to facilitate the purchase of a collection of songs from a commercial site are often configured to take into consideration prior purchases of the user, and exclude from the purchase-playlist any material that the user is known to currently possess, as a convenience to the user. The user is also provided the option of manually deleting items in the purchase-playlist, and will typically delete items already possessed, to avoid purchasing redundant material.

It is an object of this invention to provide a playlist generator that integrates the selection of entertainment items from a user's collection with the selection of items from beyond the user's collection. It is a further object of this invention to facilitate the sampling of new entertainment selections among the rendering of selections from a user's collection. It is a further object of this invention to facilitate the purchase of new items for addition to a user's collection.

These objects, and others, are achieved by a system and method for playlist generation that augments a playlist derived from selections from a user's collection with selections from beyond the user's collection. Both the user's collection and external sources are searched for entertainment items that conform to the user's preferences, and the resultant playlist includes a mix of material from both the user's collection and the external sources. The user is provided the option of specifying the proportion of material that is to be included in the playlist from the external sources. If the material from the external sources requires a purchase fee, the user is provided the option of purchasing the material, preferably, after being given the opportunity to view, listen to, or otherwise assess the material.

Following are descriptions of illustrative embodiments of the present invention that, when taken in conjunction with the drawing will demonstrate the above noted features and advantages, as well as other features and advantages.

The drawing is included for illustrative purposes and is not intended to limit the scope of the invention. In the drawing:

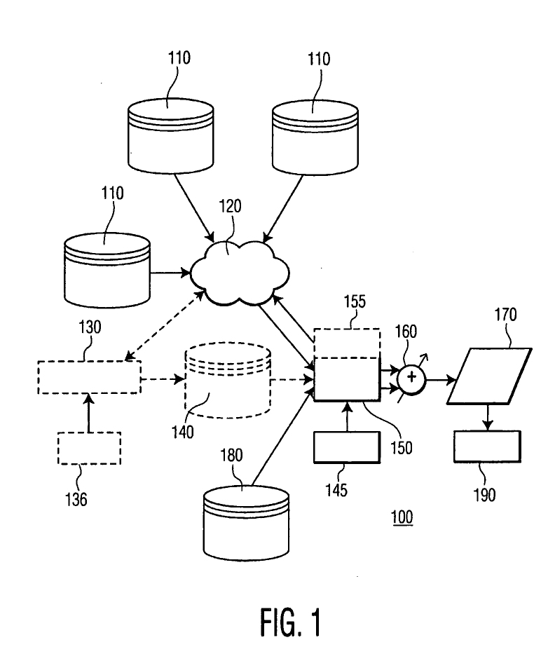

FIG. 1 illustrates an example block diagram of an integrated playlist generator in accordance with this invention.

As illustrated in FIG. 1, a playlist generator 100 includes a selector 150 that is configured to select material from a user's collection of material 180, as well as from one or more other sources of material 110, typically via a network 120, such as the Internet. The selector 150 selects the material from the user's collection 180 and from the other sources 110 based on a set of user preferences 145, and provides these selections to a mixer 160. The mixer 160 is configured to allow the user to adjust the relative proportion of material from each of the user collection 180 and other sources 110 for inclusion in a playlist 170. Although illustrated as separate entities, for ease of understanding, one of ordinary skill in the art will recognize that the mixer 160 will typically be embodied in the same functional module as the selector 150. Optionally, the playlist generator 100 may also include a rendering device 190 for rendering the material identified in the playlist 170, or the playlist 170 may be provided to a separate rendering system.

The selector 150 selects the material from the user's collection and from the sources 110 based on the user's preferences 145 using techniques common in the art. Typically the user's preferences 145 include both general preferences, or tastes, that generally affect all playlists for this user, as well as specific preferences for a particular playlist. For example, the user's tastes may include rock-and-roll music, country-western music, and exclude heavy-metal and jazz. The user's specific preferences for a particular playlist may include further refinements intended to provide a particular ambiance, such as dinner-music, romantic-music, dance-music, etc., or to correspond to the user's current mood or listening preferences, such as female-vocalists, ballads, and so on.

Typically, a user's collection 180 will reflect the user's general tastes, but the sources 110 will not. Optionally, a pre-selector, hereinafter termed a recommender 130, may be provided to preselect material from the sources 110 based on the user's general tastes 135, to provide a smaller subset 140 of the material from the sources 110 for the selector 150 to choose from. Copending U.S. patent application ______, “HIERARCHICAL PLAYLIST GENERATOR”, filed ______ for Fabio Vignoli and Steffen Pauws, and incorporated by reference herein, discloses the advantages in coherency that can be achieved via a hierarchical structuring of selectors based on time-invariant preferences, such as general tastes, and time or event dependent preferences, such as the user's mood, or intended ambiance. If such a recommender 130 is used to pre-filter the available material from the sources 110 based on the user's tastes 135, the user preferences 145 need not include these general tastes, and can be configured to merely reflect the user's preferences for the particular playlist 170. As noted above with regard to the mixer 160, the optional recommender 130 is illustrated as a separate entity from the selector 150 for ease of understanding, although one of ordinary skill in the art will recognize that the recommender 130 and selector 150 may be included in a common selector module.

The mixer 160 combines selections from both the user collection 140 and the sources 110, based on a requested proportion of new-songs to be included in the playlist 170, wherein a new-song is herein defined as a song that is not currently located in the user's collection 180. Optionally, the mixer 160 may be configured to keep a record of the new-songs that were included in prior playlists 170, and the definition of new-song is expanded to exclude songs that were previously included in prior playlists 170, regardless of whether the user added such songs to the user collection 180. If the user selects, for example, ten percent as the desired proportion of new-songs, then approximately one new-song will be included in the playlist 170 for each nine songs from the user collection 180. The new material in the playlist 170 may be highlighted or otherwise distinguished from the other material in the playlist 170, to alert the user to the presence of this new material.

If the material from the source 110 is available for rendering free-of-charge, the mixer 160 merely adds it to the playlist 170 with an appropriate identifier for locating the item, such as the Universal Resource Locator (URL) address associated with the material. Optionally, the mixer 160 can be configured to initiate a pre-download of the material to the user's system, to facilitate a delay-free rendering of the material, and stores the target location of the downloaded material in the playlist 170.

If the material from the source 110 has an associated purchase or license fee, the operation of the playlist generator 100 will depend upon the copy-protection scheme used to prevent the unauthorized rendering of the protected material. U.S. Pat. No. 6,314,518, “SYSTEM FOR TRANSFERRING CONTENT INFORMATION AND SUPPLEMENTAL INFORMATION RELATING THERETO”, issued 6 Nov. 2001 to Johann P. M. G. Linnartz, for example, presents a technique for the protection of copyright material via the use of a watermark “ticket” that controls the number of times the protected material may be rendered, and is incorporated by reference herein. Other limited-access schemes may also be used, such as a “play-but-don't-copy” protection scheme. By allowing at least one “free” rendering of the material, the user is provided the opportunity to listen to or view the material, to assess the material before potentially purchasing the material for addition to the user's collection.

Optionally, the playlist generator 100 includes a “buy” module 155 that facilitates the purchase of the new material that is included in the playlist 170. In one embodiment of this invention, when new material is being rendered, and for a brief period thereafter, a “buy button” is enabled on the user's system. Copending U.S. patent application, “METHOD AND SYSTEM FOR PURCHASING CONTENT RELATED MATERIAL”, Ser. No. ______, filed ______ for ______, Attorney Docket ______ (Disclosure 700798), discloses a system and method that facilitates the purchase of material related to rendered content material, and is incorporated by reference herein. If the user desires to purchase the selection for addition to the user's collection 180, the user activates the buy button, and the system communicates the appropriate purchase information, such as the user's credit card number, e-mail address, and so on, to the vendor of the identified material. In response, the vendor either sends another copy of the material with appropriate access and copy permissions to the user, or sends a key to unlock the protection mechanisms on the downloaded free copy of the material.

If the new material is not provided with at least one free rendering, the user is notified at the time that the playlist 170 is being created of the existence of this new material, but the identifier of the new material is not added to the playlist 170 until and unless the user decides to purchase the new material. In some instances, such as when the new material is performed by the user's favorite artist, or when the user has heard favorable reports about the material, or when the title looks appealing and the cost is relatively trivial, the user will merely activate the above referenced buy-button to purchase the rights to add the material to the user collection 180. In other instances, the user will activate a “find info” option provided by the selector 150, and will be directed to the vendor's site to receive additional information to facilitate the user's choice of whether to purchase the material.

Optionally, if the user decides to add the new material to the user's collection 180, ancillary information associated the new material, in addition to the title and artist, such as the genre, composer, and other characterizing features or parameters, is also provided to the user's system 100. This ancillary information can be stored in a memory of the user's system 100, for subsequent use by the system 100 or other systems, to further define or refine the defined user's tastes 135 and preferences 155 to facilitate future selections, using machine-learning techniques common in the art.

It should be noted that the selection of new material by the selector 150 may include other criteria, in addition to the user preferences. For example, the aforementioned copending U.S. patent application “HIERARCHICAL PLAYLIST GENERATOR”, also discloses a system and method that recommends selections to a user based on the user's preferences and based on the current popularity of songs, wherein the popularity of each song is based on the number of times other users have requested the song during a given time period. In an example embodiment, the user of this invention specifies the proportion of new items to be included in the playlist, and also specifies whether the popularity of each new item should be considered in the selection process. Other decision criteria may be included as well. For example, the aforementioned U.S. patent application 2002/0138630, “MUSIC SELECTION ALGORITHM”, provides a variety of criteria that can be used to filter selections for a particular user, each of which could be incorporated into the selector 150 for selecting new material to be presented to the mixer 160 for inclusion in the playlist 170.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

1. A system comprising:
a playlist generator that includes:
a selector that is configured to select:
a plurality of items from a collection of items of a user, and
one or more new-items from one or more other sources of items; and
a mixer that is configured to generate a playlist from the plurality of items and one or more new-items,
wherein
the selector is configured to select the plurality of items and one or more new-items based on preferences of the user, and
the collection of items of the user does not include the one or more new-items.

2. The system of claim 1, further including
the collection of items of the user.

3. The system of claim 1, further including
a rendering device that is configured to render the items identified in the playlist.

4. The system of claim 1, further including
a purchase module that is configured to facilitate a selective purchase of each of the one or more new-items.

5. The system of claim 1, wherein
the selector includes a memory that is configured to store identifications of previously selected new-items, and
the one or more new-items exclude the previously selected new-items, based on the identifications.

6. The system of claim 1, further including
a recommender module that is configured to create of subset of source items from the one or more other sources of items, based on one or more general preferences of the user,
wherein
the selector selects the one or more new-items from the subset of source items.

7. The system of claim 1, wherein
the one or more other sources of items are accessible via an Internet access.

8. The system of claim 1, wherein
the mixer is configured to allow the user to control a relative proportion of the new-items relative to the plurality of items from the collection of items.

9. The system of claim 1, wherein
the selector is further configured to select the one or more new-items based on a popularity of each new-item of the one or more new-items.

10. The system of claim 1, wherein
the system is further configured to facilitate selectively adding each new-item of the one or more new-items to the collection of items.

11. The system of claim 11, further including
a memory that is configured to store ancillary information associated with each new-item that is selectively added to the collection of items, to facilitate subsequent selections.

12. A method of generating a playlist, comprising:
selecting a plurality of items from a collection of items of a user, based on preferences of the user,
selecting one or more new-items from one or more other sources of items, based on preferences of the user, and
combining the plurality of items and the one or more new-items, to provide therefrom the playlist,
wherein
the one or more new-items are exclusive of items in the collection of items of the user.

13. The method of claim 12, further including
rendering the items of the playlist.

14. The method of claim 12, further including
enabling a selective purchase of each of the one or more new-items.

15. The method of claim 12, further including
storing identifications of previously selected new-items, and
wherein
the one or more new-items are exclusive of the previously selected new-items.

16. The method of claim 12, further including
creating a subset of source-items from the other sources of items, based on one or more general preferences of the user, and
wherein
selecting the one or more new-items from the one or more other sources of items includes
selecting the one or more new-items from the subset of source-items.

17. The method of claim 12, further including
determining a preferred proportion of new-items relative to the plurality of items, and
wherein
combining the plurality of items and the one or more new-items to provide the playlist is based on the preferred proportion.

18. The method of claim 12, wherein
selecting the one or more new-items is further based on a popularity of each new-item of the one or more new-items.

19. The method of claim 12, further including
selectively adding each new-item of the one or more new-items to the collection of items.

20. The method of claim 19, further including
storing ancillary information corresponding to each new-item that is selectively added to the collection of items to facilitate future selections.
